(19) United States
(12) Patent Application Publication
(10) Pub. No.: US 2015/0269341 A1
(43) Pub. Date: Sep. 24, 2015

(54) METHOD AND SYSTEM FOR INTERVENTION MANAGEMENT

(71) Applicant: Home Care Assistance, Inc., Palo Alto, CA (US)

(72) Inventors: James Harding Johnson, Palo Alto, CA (US); Samuel Thomas Gontkovsky, San Francisco, CA (US)

(73) Assignee: Home Care Assistance, Inc., Palo Alto, CA (US)

(21) Appl. No.: 14/220,266

(22) Filed: Mar. 20, 2014

(51) Int. Cl. G06F 19/00

(52) U.S. Cl. CPC G06F 19/3418

(57) ABSTRACT

A system and method for managing interventions for chronic progressive neurodegenerative conditions are provided. The method includes receiving a client for evaluation, determining a first level of functioning in each of a plurality of cognitive domains, comparing the determined first level of functioning to one or more threshold levels of functioning, and determining one or more intervention activities associated with each cognitive domain when at least one of the determined functioning is less than a respective threshold level and the determined functioning meets the threshold level and a determination is made that the client will benefit from further exercise in the cognitive domain. The method also includes administering the interventions in a usual living space of the client, evaluating a second level of functioning during the administering, reporting the second level of functioning, evaluating each level of functioning administered over time, and reporting a progress of the client over time.

### BACKGROUND OF THE DISCLOSURE

This description relates to intervention planning, and, more particularly, to a network-based method and system for generating and administering a personalized intervention plan for an individual based on a comprehensive evaluation process.

Dementia is a serious loss of cognitive ability in a previously-unimpaired person, beyond what might be expected from normal aging. It may be static, the result of a unique global brain injury, or progressive, resulting in long-term decline due to damage or disease in the body. Although dementia is far more common in the geriatric population, it may occur in any stage of adulthood. Dementia which begins gradually and worsens progressively over several years is usually caused by neurodegenerative disease, that is, by conditions affecting only or primarily the neurons of the brain and causing gradual but irreversible loss of function of these cells.

Dementia is a non-specific illness syndrome in which affected areas of cognition may be memory, attention, language, visual-spatial perception, and executive functioning, as well as basic and instrumental activities of daily living (ADLs), social skills, and behavioral disturbances. Especially in the later stages of the condition, affected persons may be disoriented in time (not knowing what day of the week, day of the month, or even what year it is), in place (not knowing where they are), and in person (not knowing who they are or others around them). The causes of dementia depend on the age at which symptoms begin. In the elderly population (usually defined in this context as over 65 years of age), a large majority of cases of dementia are caused by Alzheimer's disease and vascular dementia. Dementia with Lewy bodies is another fairly common cause, which again may occur alongside either or both of the other causes. Hypothyroidism sometimes causes slowly progressive cognitive impairment as the main symptom, and this may be fully reversible with treatment. Normal pressure hydrocephalus, though relatively rare, is important to recognize since treatment may prevent progression and improve other symptoms of the condition. However, significant cognitive improvement is unusual.

Various types of brain injury, occurring as a single event, may cause irreversible but fixed cognitive impairment. Traumatic brain injury may cause generalized damage to the white matter of the brain, or more localized damage. A temporary reduction in the brain's supply of blood or oxygen may lead to hypoxic-ischemic injury. Strokes (ischemic stroke, or intracerebral, subarachnoid, subdural or extradural hemorrhage) or infections (meningitis and/or encephalitis) affecting the brain, prolonged epileptic seizures and acute hydrocephalus may also have long-term effects on cognition. Excessive alcohol use may cause either alcohol dementia or Korsakoff s psychosis (and certain other recreational drugs may cause substance-induced persisting dementia); once overuse ceases, the cognitive impairment is persistent but non-progressive.

Alzheimer's disease (AD), also called Alzheimer disease, senile dementia of the Alzheimer Type (SDAT) or simply Alzheimer's, is the most common form of dementia. It is an incurable, degenerative, and terminal disease and is generally diagnosed in people over 65 years of age, although the less-prevalent early-onset Alzheimer's can occur much earlier, in 2006, there were 26.6 million sufferers worldwide, with about ⅓ of people over the age of 80 suffering from it. Alzheimer's is predicted to affect 1 in 85 people globally by 2050. Public expenditure on AD is overwhelming, reaches nearly 100 B$ per annum in the United States alone, and over 250 B$ per annum in the largest seven western countries. Although the course of Alzheimer's disease is unique for every individual, there are many common symptoms. In the early stages, the most commonly recognized symptom is memory loss, such as difficulty in remembering recently learned facts. Diagnosis is usually confirmed with behavioral assessments and cognitive tests, sometimes followed by a brain scan. As the disease advances, symptoms include confusion, irritability and aggression, mood swings, language breakdown, long-term memory loss, and the general withdrawal of the sufferer as their senses decline. Gradually, bodily functions are lost, ultimately leading to death.

Currently used treatments offer only a minor symptomatic benefit; no treatments significantly delaying (beyond 3-6 months) or halting the progression of the disease are as yet available. Mental stimulation, exercise, and a balanced diet have been suggested, as both a possible prevention and a sensible way of managing the disease. Most patients today receive drugs of the family choline-esterase-inhibitors (ChEI), which increase the concentration in the brain of acetyl-choline. However, some do not see any improvement from the drug, and for others improvement caused by the drug lasts between 3 and 12 months, and then the normal degradation of the patient resumes. Other treatments being attempted include magnetic stimulation of selected regions of the brain.

### BRIEF DESCRIPTION OF THE DISCLOSURE

In one aspect, a computer-implemented method for managing interventions for chronic progressive neurodegenerative conditions is implemented using a computer device coupled to a user interface and a memory device wherein the method includes receiving a client for evaluation, determining a first level of functioning in each of a plurality of cognitive domains, comparing the determined first level of functioning to one or more threshold levels of functioning, the threshold levels determined from at least one of others than the client and previous determinations of the client, and determining one or more intervention activities associated with each cognitive domain when at least one of the determined functioning is less than a respective threshold level and the determined functioning meets the threshold level and a determination is made that the client will benefit from further exercise in the cognitive domain. The method also includes administering the interventions in a usual living space of the client, evaluating a second level of functioning during the administering, reporting the second level of functioning, evaluating each level of functioning administered over time, and reporting a progress of the client over time with respect to the interventions and the evaluated levels functioning in each of the plurality of cognitive domains.

In another aspect, a network-based intervention management system (IMS) for managing interventions for chronic progressive neurodegenerative conditions includes a network including a memory device and a computing device coupled to the memory device, the computing device is programmed to receive client evaluation information, receive a first level of functioning information in each of a plurality of cognitive domains and non-cognitive areas based at least in part on the received information, and compare the determined first level of functioning to one or more threshold levels of functioning, the threshold levels determined from at least one of others than the client and previous determinations of the client. The computing device is also programmed to receive a selection of one or more intervention activities associated with each cognitive domain where the determined functioning was less than a respective threshold level, receive a score of an administration of the interventions in a usual living space of the client, receive a second level of functioning information based on the administering, and generate a report of progress of the client over time with respect to the interventions and the evaluated levels functioning in each of the plurality of cognitive domains.

In yet another aspect, one or more non-transitory computer-readable storage media includes computer-executable instructions embodied thereon, wherein when executed by at least one processor, the computer-executable instructions cause the processor to receive client evaluation information, receive a first level of functioning information in each of a plurality of cognitive domains and non-cognitive areas based at least in part on the received information, and compare the determined first level of functioning to one or more threshold levels of functioning, the threshold levels determined from at least one of others than the client and previous determinations of the client. The computer-executable instructions also cause the processor to receive a selection of one or more intervention activities associated with each cognitive domain where the determined functioning was less than a respective threshold level, receive a score of an administration of the interventions in a usual living space of the client, receive a second level of functioning information based on the administering, and generate a report of progress of the client over time with respect to the interventions and the evaluated levels functioning in each of the plurality of cognitive domains.

### BRIEF DESCRIPTION OF THE DRAWINGS

FIGS. 1-14 show example embodiments of the method and apparatus described herein.

FIG. 1 is a diagram depicting an example networked environment for managing client interventions as part of a personalized cognitive training plan designed based on evaluation of the client.

FIG. 2 is a diagram of example computing devices that may be used in the environment shown in FIG. 1.

FIG. 3 is a flowchart of an example method for providing interventions for chronic progressive neurodegenerative conditions in accordance with an example embodiment of the present disclosure.

FIG. 4 is a screen capture of a login screen generated in the Intervention Management System (IMS) shown in FIG. 1 for receiving a user login to the IMS.

FIG. 5 is a screen capture of a clients list screen in accordance with an example embodiment of the present disclosure.

FIG. 6 is a screen capture of an intervention plan for a specific client.

FIG. 7 is a screen capture of an intervention instruction screen in accordance with an example embodiment of the present disclosure.

FIG. 8 is a screen capture of a stimulus link screen associated with the stimulus link shown in FIG. 7.

FIG. 9 is a screen capture of an answers link screen associated with the stimulus link shown in FIG. 7.

FIG. 10 is a screen capture of an interventionist screen generated in IMS 106, listing interventionists who are currently staffed on a client case and interventionists who are trained and available to be staffed on a case.

FIG. 11 is a screen capture of an interventions screen generated in the IMS shown in FIG. 1, listing activities that can be assigned to a client.

FIG. 12 is a screen capture of an intervention notes screen accessible to interventionists.

FIG. 13 is an example monthly report shared with the client.

FIG. 14 is another example monthly report shared with the client.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION OF THE DISCLOSURE

The following detailed description illustrates embodiments of the disclosure by way of example and not by way of limitation. It is contemplated that the disclosure has general application to analytical and methodical embodiments of administering and managing a plurality of selected interventions to a client based at least in part on a comprehensive evaluation and information gathering process.

Embodiments of the disclosure describe a cognitive therapeutic intervention program for certain clients. The program is highly personalized, and intervention plans are created for each client based on a comprehensive evaluation process. A research team develops an intervention plan by selecting activities that are most appropriate and meaningful to the client from a comprehensive list of more than 300 activities. These activities target various domains that have been shown by research to impact cognitive functioning of a client, and include all of the five primary cognitive domains and at least some of the non-cognitive areas including a coping area, a sensory area, a social area, a recreational area, an exercise area, and a diet area. Activities are administered by an interventionist, who has a minimum of a bachelor's degree in psychology, nursing or related area, and has completed extensive training. In addition, a monthly review of activities performed and progress is reported. The cognitive therapeutic intervention program is offered to any client with cognitive issues, ranging in degree from mild forgetfulness to more severe dementia, regardless of his/her home care needs. The cognitive therapeutic intervention program is also offered to clients who are not affected by dementia yet, but who may want to be mentally engaged to keep their mind sharp.

An evaluation entails one to two hours of in-person time with the client and family members. It includes a proprietary behavioral rating scale, life history questionnaire, and several standardized testing instruments. The initial evaluation determines the extent of the client's needs and allow our research team to develop a tailored intervention plan and schedule. The activities are administered by trained interventionists. Typically, clients receive between three and ten hours of activities per week where a minimum weekly commitment is three hours.

A monthly progress update including activities administered, proportion of time spent on each domain, and additional feedback is presented to the client and the family of the client. An annual re-evaluation is used to review the client's progress and note any changes in condition or intervention plan. There is also an intermediary re-evaluation during the first year of service, and intervention plans are constantly revised as a result of client and interventionist feedback throughout the course of the program.

As used herein, “cognitive training” refers to any nonpharmacological intervention designed to improve cognition, regardless of mechanism of action. Typically, cognitive training focuses on specific cognitive domains or cognitively mediated domains of functioning, such as basic and instrumental activities of daily living (ADLs), social skills, and behavioral disturbances. Cognitive training includes cognitive stimulation, memory rehabilitation, reality orientation, and neuropsychological rehabilitation. A recent metaanalysis of studies testing cognitive training for early-stage AD between 1980 and 2004 supports that cognitive training is effective. Specifically, medium effect sizes were observed for learning, memory, executive functioning, ADLs, general cognitive problems, depression, and self-rated general functioning.

As used herein, cognition is a general term for mental processes by which an individual acquires knowledge, solves problems, and plans activities. Cognitive skills include attention, visual-spatial perception, executive functioning, memory and language, among others. The functional levels of each of these skills can be studied alone or in combination for a particular individual.

The following description refers to the accompanying drawings, in which, in the absence of a contrary representation, the same numbers in different drawings represent similar elements.

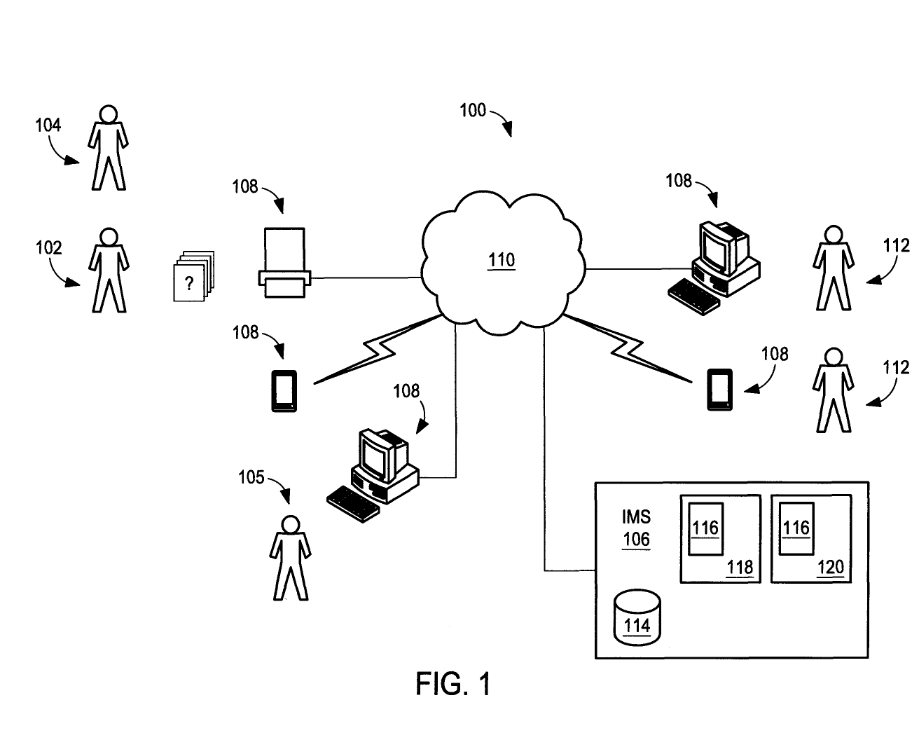

FIG. 1 is a diagram depicting an example networked environment 100 for managing client interventions as part of a personalized cognitive training plan designed based on evaluation of the client. In the example embodiment, environment 100 may be referred to as an intervention management system and the interventions may be addressing concerns related to a neurodegenerative disease, such as, but, not limited to dementia, or other related non-specific illness syndromes. Networked environment 100 may include one or more interventionists 102 that interface in-person with a client 104, one or more research and operations professionals or a research and operations team 105, an intervention management system (IMS) 106, and one or more user access devices 108 (“client computing devices”), which may be coupled to a network 110. As used herein, interventionist refers to trained professionals who visit the client in a home setting of the client to perform interventions. User access devices are used by users such as, but, not limited to interventionists 102, research and operations team 105, and family members 112 of client 104. Each of IMS 106 and user access devices 108 may be implemented or associated with hardware components, software components, or firmware components or any combination of such components. IMS 106 and user access devices 108 can, for example, be implemented or associated with general purpose servers, software processes and engines, and/or various embedded systems.

IMS 106 manages content and provides various services to interventionists 102, research and operations team 105, and family members 112 through user access devices 108. IMS 106 may store content in a content repository 114. In the example embodiment, content refers to information relating to managing interventions. For example, content may include interventions instructions, interventions answer keys and client information including life history questionnaires to be completed by client 104 and/or family members 112. Content may also refer to results of the client progress and evaluation in raw form or processed form, which allows dissemination to family members 112 or is used in reporting client progress to research and operations team 105.

IMS 106 may include one or more data processing systems 116, such as servers or embedded systems, coupled to network 110. It can also include one or more processes, such as server processes. In some examples, IMS 106 may include a content serving system 120 and one or more backend processing systems 118. The content serving system 120 may include one or more data processing systems 116 and may perform functionality associated with delivering content to user access devices 108. Backend processing systems 118 may include one or more data processing systems 116 and may perform functionality associated with preparing content to deliver, processing various rules, performing filtering processes, generating reports, maintaining accounts and usage information, managing incoming reports, questionnaire answers, and other backend system processing.

IMS 106 may include one or more interface or frontend modules for providing the various features to user access devices 108. For example, IMS 106 may provide one or more front-end interfaces for allowing family members 112 to interact with IMS 106. In some examples, the front-end interfaces may be configured as web applications that provide users with network access to features available in IMS 106. Such access is provided to client 104, family members, and/or those with guardianship responsibilities for client 104 and the person(s) can share the access information with others including but not limited to physicians and extended family members. Additional state and/or federal rules regarding access to client information may also apply.

IMS 106 provides various content management features to the interventionists 102 and research and operations team 105. IMS 106 features may allow research and operations team 105 to set up client accounts, set account preferences, create content, create intervention plans for each client 104, and view reports associated with accounts as described herein.

“Computing devices”, for example user access devices 108, may include any devices capable of receiving information from network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

Network 110 may include any element or system that facilitates communications among and between various network nodes. Network 110 may include one or more telecommunications networks, such as computer networks, telephone or other communications networks, the Internet, etc. Network 110 may include a shared, public, or private data network encompassing a wide area (e.g., WAN) or local area (e.g., LAN). In some implementations, network 110 may facilitate data exchange by way of packet switching using the Internet Protocol (IP). Network 110 may facilitate wired and/or wireless connectivity and communication.

For purposes of explanation only, certain aspects of this disclosure are described with reference to the discrete elements illustrated in FIG. 1. The number, identity and arrangement of elements in environment 100 are not limited to what is shown. For example, environment 100 can include any number of geographically-dispersed content providers 102, publishers 104 and/or user access devices 108, which may be discrete, integrated modules or distributed systems. Similarly, environment 100 is not limited to a single IMS 106 and may include any number of integrated or distributed IMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

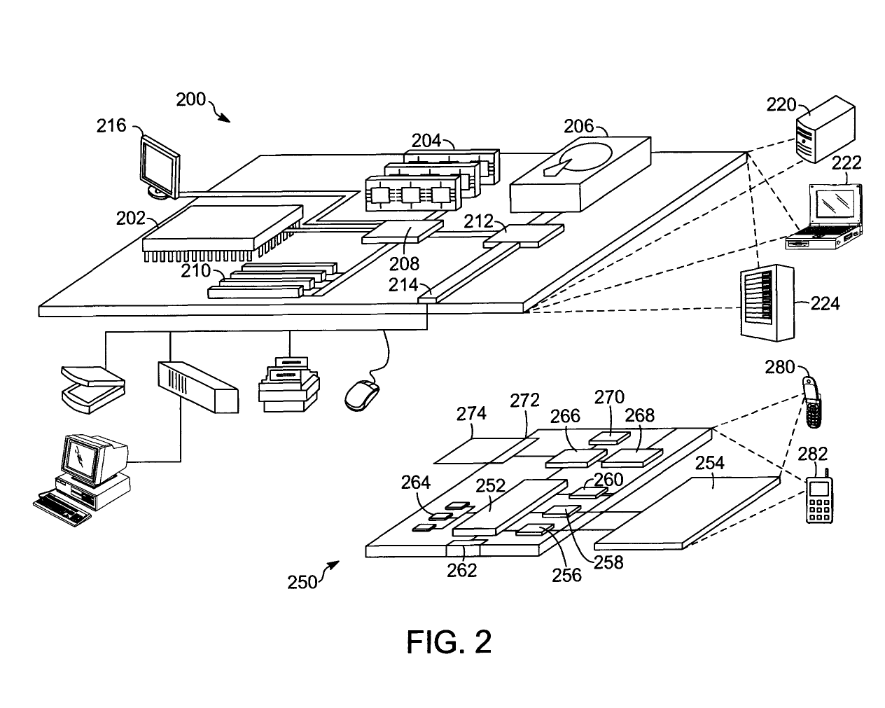

FIG. 2 is a diagram of example computing devices 200 and 250 that may be used in environment 100 shown in FIG. 1. More specifically, FIG. 2 shows an example of a generic computing device 200 and a generic mobile computing device 250, which may be used with the techniques described here. Computing device 200 is intended to represent various forms of digital computers, such as laptops, desktops, workstations, personal digital assistants, servers, blade servers, mainframes, and other appropriate computers. Computing device 250 is intended to represent various forms of mobile devices, such as personal digital assistants, cellular telephones, smart phones, and other similar computing devices. The components shown here, their connections and relationships, and their functions, are meant to be examples only, and are not meant to limit implementations of the disclosures described and/or claimed in this document.

Computing device 200 includes a processor 202, a memory 204, a storage device 206, a high-speed interface/controller 208 connecting to memory 204 and high-speed expansion ports 210, and a low speed interface/controller 212 connecting to a low speed bus 214 and storage device 206. Each of the components 202, 204, 206, 208, 210, and 212, are interconnected using various busses, and may be mounted on a common motherboard or in other manners as appropriate. The processor 202 can process instructions for execution within the computing device 200, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

The memory 204 stores information within the computing device 200. In one implementation, the memory 204 is a volatile memory unit or units. In another implementation, the memory 204 is a non-volatile memory unit or units. The memory 204 may also be another form of computer-readable medium, such as a magnetic or optical disk.

The storage device 206 is capable of providing mass storage for the computing device 200. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, or memory on processor 202.

The high speed controller 208 manages bandwidth-intensive operations for the computing device 200, while the low speed controller 212 manages lower bandwidth-intensive operations. Such allocation of functions is example only. In one implementation, the high-speed controller 208 is coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed buss 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200 may be implemented in a number of different forms, as shown in the figure. For example, it may be implemented as a standard server 220, or multiple times in a group of such servers. It may also be implemented as part of a rack server system 224. In addition, it may be implemented in a personal computer such as a laptop computer 222. Alternatively, components from computing device 200 may be combined with other components in a mobile device (not shown), such as computing device 250. Each of such devices may contain one or more of computing device 200, 250, and an entire system may be made up of multiple computing devices 200, 250 communicating with each other.

Computing device 250 includes a processor 252, memory 264, an input/output device such as a display 254, a communication interface 266, and a transceiver 268, among other components. The computing device 250 may also be provided with a storage device, such as a microdrive or other device, to provide additional storage. Each of the components 250, 252, 264, 254, 266, and 268, are interconnected using various buses, and several of the components may be mounted on a common motherboard or in other manners as appropriate.

The processor 252 can execute instructions within the computing device 250, including instructions stored in the memory 264. The processor may be implemented as a chipset of chips that include separate and multiple analog and digital processors. The processor may provide, for example, for coordination of the other components of the computing device 250, such as control of user interfaces, applications run by computing device 250, and wireless communication by computing device 250.

Processor 252 may communicate with a user through control interface 258 and display interface 256 coupled to a display 254. The display 254 may be, for example, a TFT LCD (Thin-Film-Transistor Liquid Crystal Display) or an OLED (Organic Light Emitting Diode) display, or other appropriate display technology. The display interface 256 may comprise appropriate circuitry for driving the display 254 to present graphical and other information to a user. The control interface 258 may receive commands from a user and convert them for submission to the processor 252. In addition, an external interface 262 may be provide in communication with processor 252, so as to enable near area communication of computing device 250 with other devices. External interface 262 may provide, for example, for wired communication in some implementations, or for wireless communication in other implementations, and multiple interfaces may also be used.

The memory 264 stores information within the computing device 250. The memory 264 can be implemented as one or more of a computer-readable medium or media, a volatile memory unit or units, or a non-volatile memory unit or units. Expansion memory 274 may also be provided and connected to computing device 250 through expansion interface 272, which may include, for example, a SIMM (Single in Line Memory Module) card interface. Such expansion memory 274 may provide extra storage space for computing device 250, or may also store applications or other information for computing device 250. Specifically, expansion memory 274 may include instructions to carry out or supplement the processes described above, and may include secure information also. Thus, for example, expansion memory 274 may be provide as a security module for computing device 250, and may be programmed with instructions that permit secure use of computing device 250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 264, expansion memory 274, or memory on processor 252 that may be received, for example, over transceiver 268 or external interface 262.

Computing device 250 may communicate wirelessly through communication interface 266, which may include digital signal processing circuitry where necessary. Communication interface 266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 268. In addition, short-range communication may occur, such as using a Bluetooth, Wi-Fi, or other such transceiver (not shown). In addition, GPS (Global Positioning system) receiver module 270 may provide additional navigation- and location-related wireless data to computing device 250, which may be used as appropriate by applications running on computing device 250.

Computing device 250 may also communicate audibly using audio codec 260, which may receive spoken information from a user and convert it to usable digital information. Audio codec 260 may likewise generate audible sound for a user, such as through a speaker, e.g., in a handset of computing device 250. Such sound may include sound from voice telephone calls, may include recorded sound (e.g., voice messages, music files, etc.) and may also include sound generated by applications operating on computing device 250.

The computing device 250 may be implemented in a number of different forms, as shown in the figure. For example, it may be implemented as a cellular telephone 280. It may also be implemented as part of a smart phone 282, personal digital assistant, a computer tablet, or other similar mobile device.

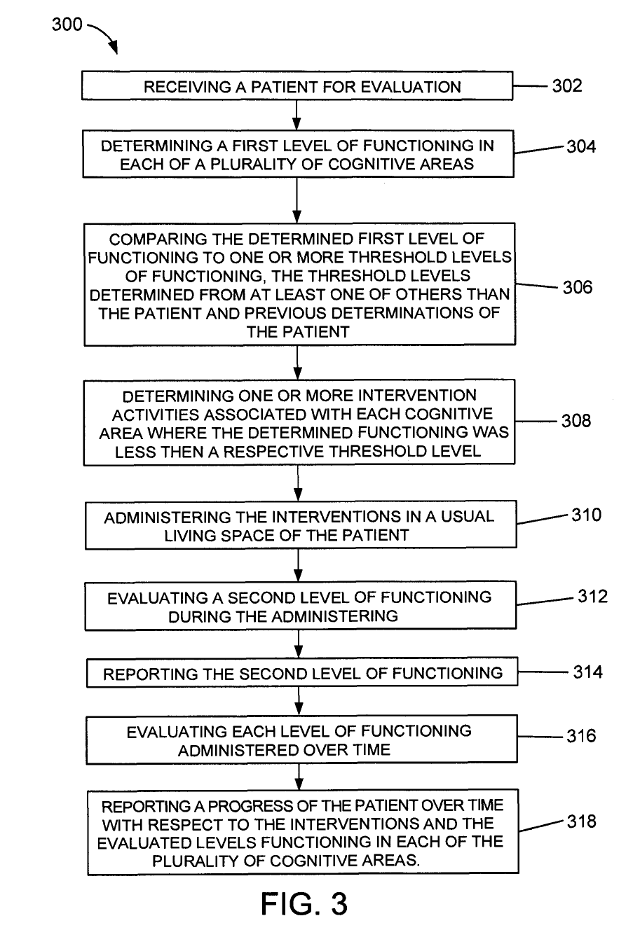

FIG. 3 is a flowchart of an example method 300 for providing interventions for chronic progressive neurodegenerative conditions. The method is typically implemented using a computer device coupled to a user interface and a memory device. In the example embodiment, the method includes receiving 302 a client for evaluation, determining 304 a first level of functioning in each of a plurality of cognitive domains and non-cognitive areas, and comparing 306 the determined first level of functioning to one or more threshold levels of functioning, the threshold levels determined from at least one of others than the client and previous determinations of the client. Method 300 further includes determining 308 one or more intervention activities associated with each cognitive domain and non-cognitive area where the determined functioning was less than a respective threshold level or where the determined functioning meets the threshold level but can still benefit from further exercise and improvement in the cognitive domain and non-cognitive area, administering 310 the interventions in a usual living space of the client, and evaluating 312 a second level of functioning during the administering. Method 300 further includes reporting 314 the second level of functioning, re-evaluating 316 each level of functioning, and reporting 318 a progress of the client over time with respect to the interventions and the evaluated levels functioning in each of the plurality of cognitive domains and non-cognitive areas.

Method 300 optionally includes modifying the administered interventions based on feedback from client and observations by interventionist, and periodically re-evaluating a current level of functioning by research and operations team 105. In various embodiments, method 300 may also include determining a first level of functioning in each of a cognitive domain including a memory area, an executive function area, an attention area, a visual-spatial area, and a language area, in addition to non-cognitive areas including the coping, sensory, recreational, social, exercise and diet areas, where determining a first level of functioning is performed by direct observation of the client by research and operations team 105. Method 300 also optionally includes receiving information relating to a life history of the client, interests of the client, and family information of the client. The information may be received by a self-administered questionnaire by the client if the client has the capacity to respond to the questionnaire. Alternatively, the questionnaire may be answered by a family member or other person knowledgeable of the history and preferences of the client.

Method 300 also optionally includes selecting one or more intervention activities from a plurality of available intervention activities based on the evaluation and the received client history information. The interventions may be selected manually by research and operations team 105, or may be selected by an algorithm executing in the IMS. The algorithm may be rule-based using the experience of a human expert to establish rules correlating data gathered by the evaluation, questionnaire, or other sources, for example, but not limited to health history, diet advancement of symptoms, noted receptiveness to particular types of activities, and known infirmaries, for example, limited mobility. In some cases, the plurality of available intervention activities based on the life history of the client, interests of the client, and family information of the client may be limited or excluded from consideration.

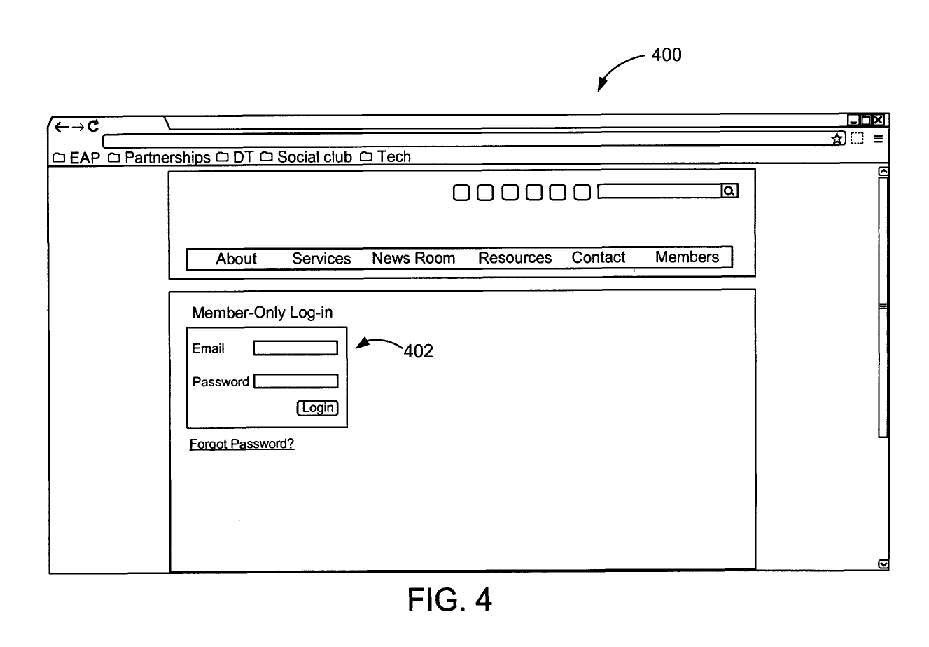

FIG. 4 is a screen capture of a login screen 400 generated in IMS 106 for receiving a user login to IMS 106. Research and operations team 105, interventionists, clients, and authorized advocates including family members, have access to the system using an assigned login, for example, but not limited to an email address/password combination 402. A level of access is different for each person based on their role in the delivery of interventions to the client. For example, managers on research and operations team 105 can view and edit all areas, interventionists can only view and edit information on clients they are assigned to including but not limited to activities performed and the clients' level of cooperation, engagement and performance (they cannot add interventions, as interventionists follow the intervention plan created by research and operations team 105), and clients can only view automatically generated reports.

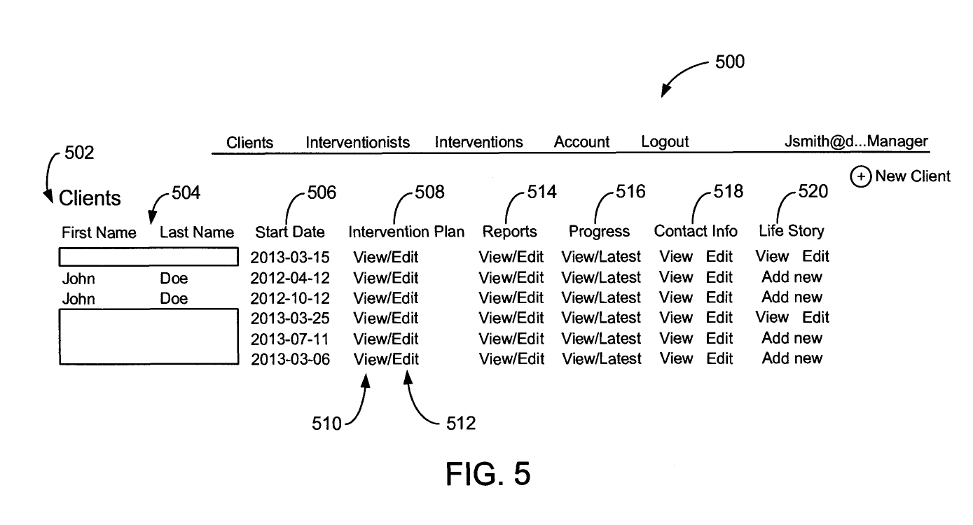

FIG. 5 is a screen capture 500 of a client list screen 502 in accordance with an example embodiment of the present disclosure. In the example embodiment, clients list 502 includes a list of clients 504 followed by columns of viewable information associated with each respective client. For example, a date column 506 indicates a date each client started in the intervention program management though IMS 106. An intervention plan column 508 includes a first sub-column 510 that permits user access to view the intervention plan associated with the respective client. Access to view the intervention plan is granted only if the permissions granted to the logged on user are sufficient for viewing the intervention plan. Similarly, intervention plan column 508 includes a second sub-column 512 that permits user access to edit the intervention plan associated with the respective client. Access to edit the intervention plan is granted only if the permissions granted to the logged on user are sufficient for editing the intervention plan. Clients list screen 502 also includes a reports column 514, a progress column 516, a contact info column 518, and a life story column 520. Each of columns 514, 516, 518, and 520 are structured similarly to intervention plan column 508 in that they each include a view sub-column and an edit sub-column. For privacy requirements, at least some names may be grayed-out, hidden, or otherwise redacted from view by users that do not have sufficient permissions.

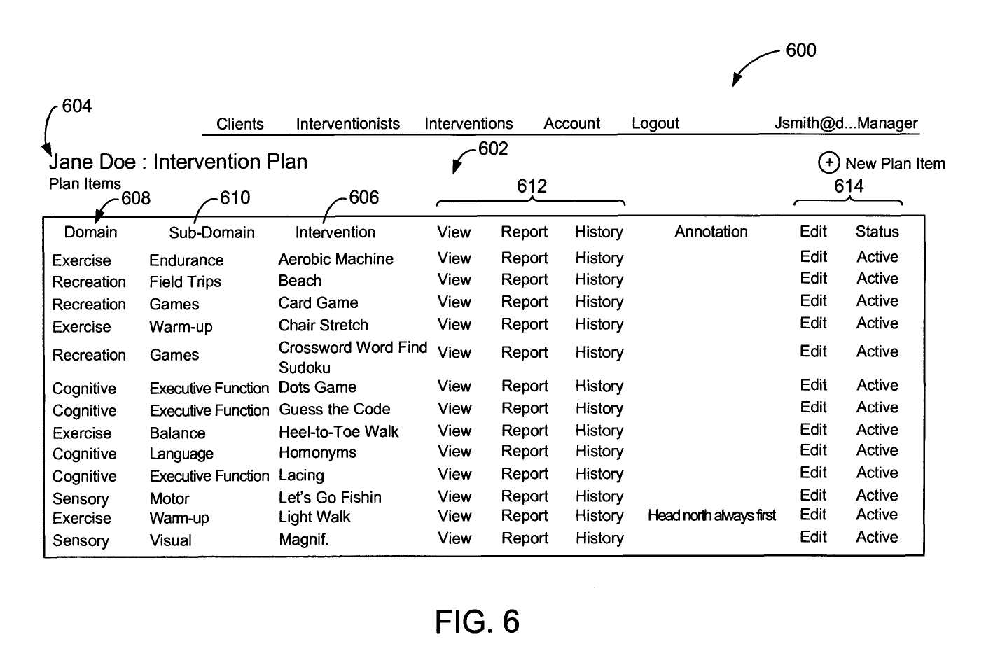

FIG. 6 is a screen capture 600 of an intervention plan 602 for a specific client. In the example embodiment, the client is Jane Doe as noted in heading 604. Intervention plan 602 includes an intervention column 606 that indicates the intervention to be performed by the client at the direction and direct observation of the interventionist. A domain column 608 identifies the domain from which the intervention is associated. A sub-domain column 610 identifies the sub-domain from which the intervention is associated. Columns 612 permit access to viewing, reporting, and a history of each intervention. An annotation column permits entry and display of comments and/or additional instructions associated with a respective intervention. Edit and status columns 614 permit access to editing and status functionality to users having sufficient permissions.

Research and operations team 105 assigns interventions to each client after reviewing assessment results to create intervention plan 602. Interventionists carry an electronic tablet or other computing device to review the list of interventions online, learn the instructions to perform the interventions, and report client's progress on each of the interventions. In various embodiments, the interventionist decides which intervention to administer each day and in what order.

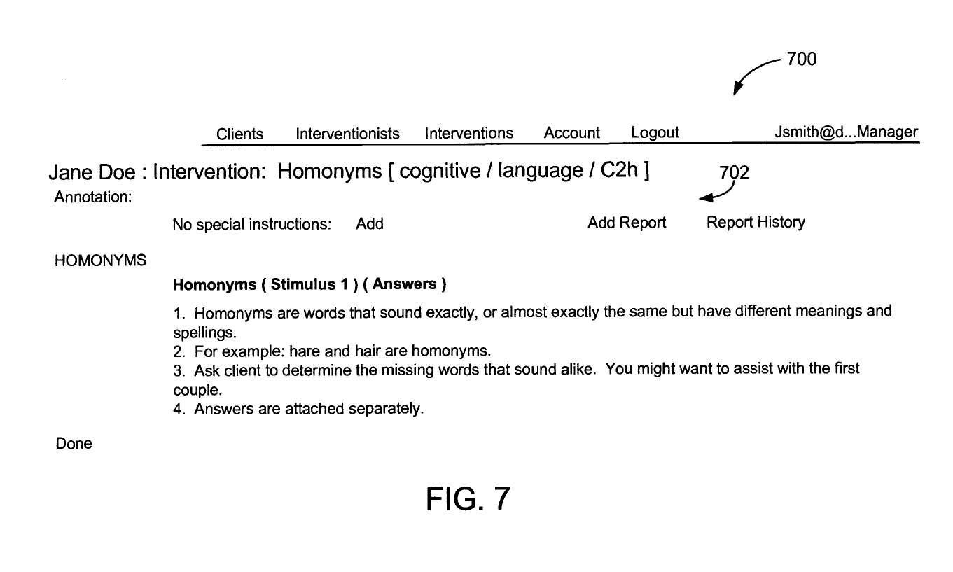

FIG. 7 is a screen capture 700 of an intervention instruction screen 702 in accordance with an example embodiment of the present disclosure. When an interventionist clicks on the “View” link of a specific intervention shown on the Intervention Plan page (shown in FIG. 6), the “View” link opens intervention instruction screen 702 to display instructions on administering that intervention, as well as links to the stimulus that should be used with the given intervention and answers to it.

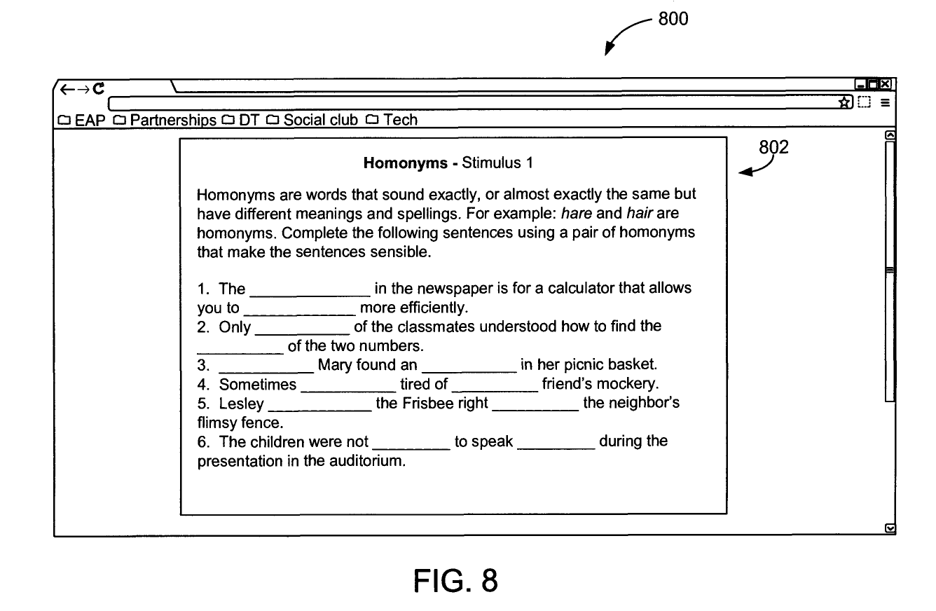

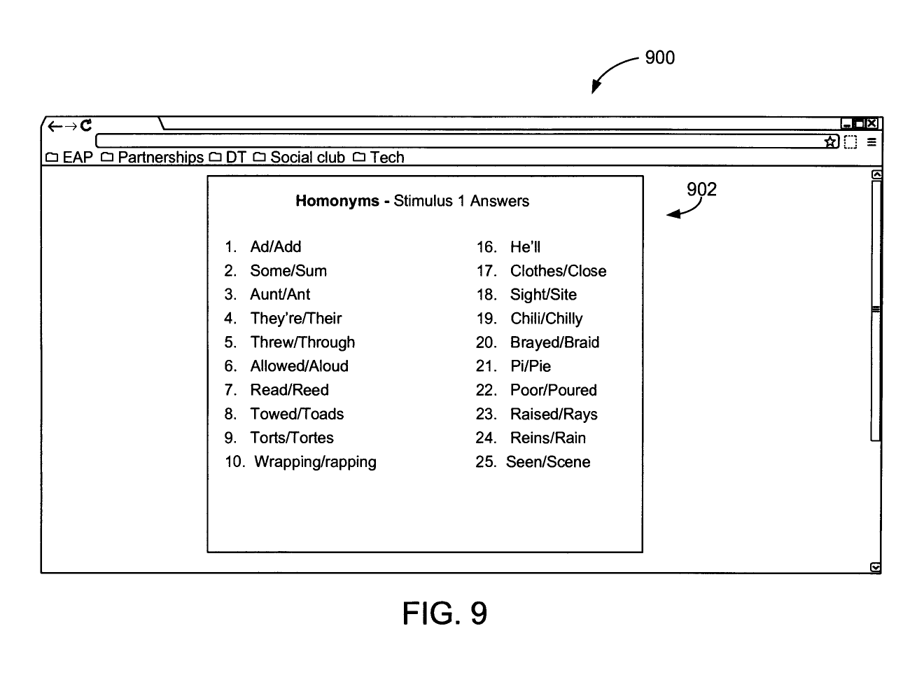

FIG. 8 is a screen capture 800 of a stimulus link screen 802 associated with the stimulus link shown in FIG. 7. FIG. 9 is a screen capture 900 of an answers link screen 902 associated with the stimulus link shown in FIG. 7.

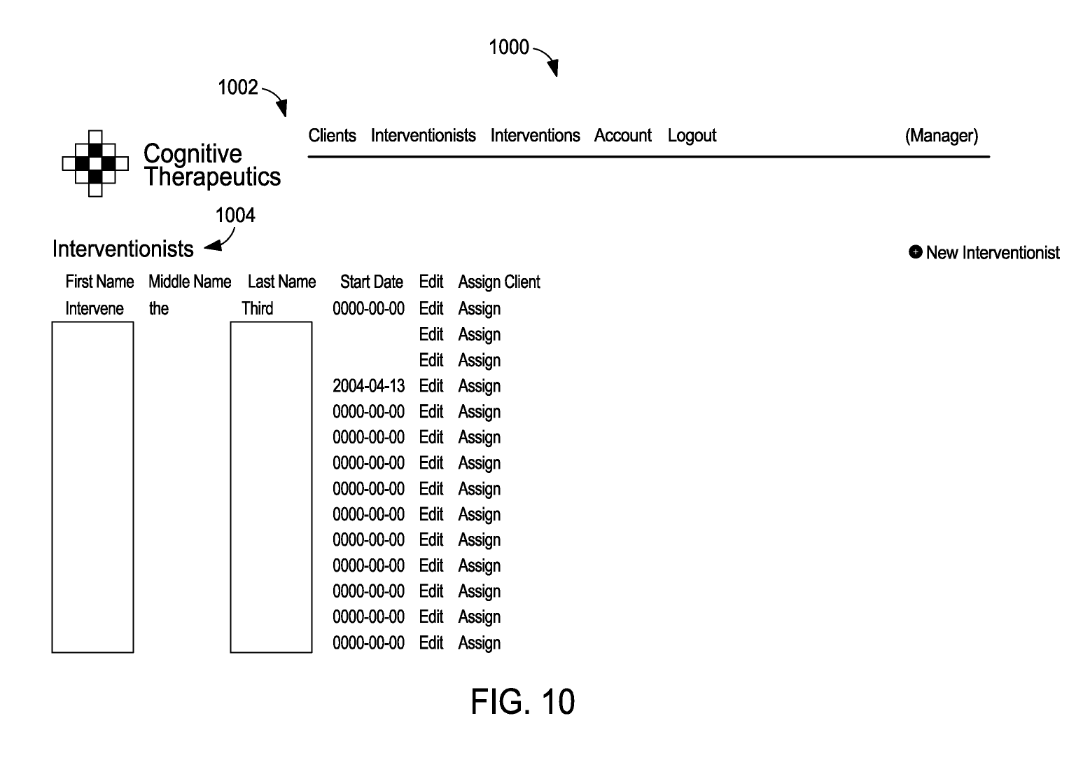

FIG. 10 is a screen capture 1000 of an interventionist screen 1002 generated in IMS 106, listing interventionists who are currently staffed on a client case and interventionists who are trained and available to be staffed on a case.

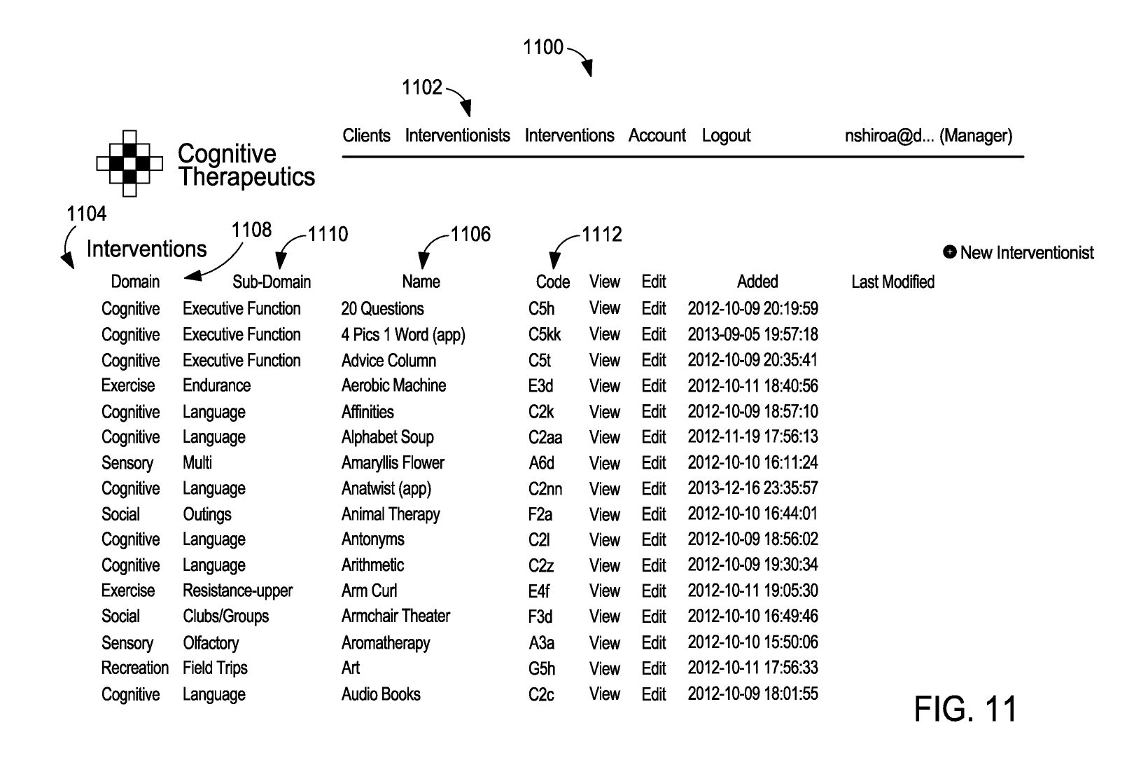

FIG. 11 is a screen capture 1100 of an interventions screen 1102 generated in IMS 106, listing activities that can be assigned to a client. Once appropriate activities are selected from this list for a client, the selected activities become an intervention plan. Each of a plurality of rows 1104 represents a different activity 1106. Each activity 1106 is listed with its associated domain 1108 and sub-domain 1110. A code 1112 further identifies each activity 1106.

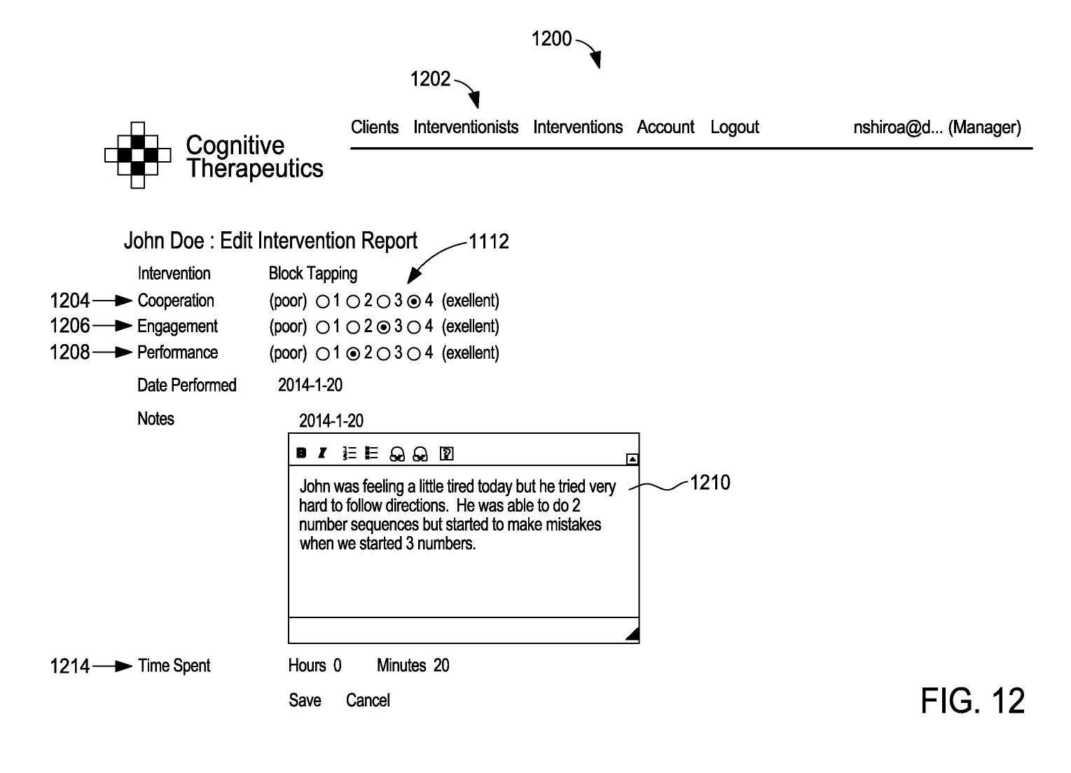

FIG. 12 is a screen capture 1200 of an intervention notes screen 1202 accessible to interventionists. After each activity 1106, the interventionist rates the client's cooperation 1204, engagement 1206, and performance level 1208, as well as adding any notes in a note field 1210 to supplement the scores. A selectable rating scale 1212 is used to permit entry of the rating on different scales selectable by the interventionist. The different scales permit more meaningful entries for each area being rated. The interventionist also notes the time spent 1212 on each activity, which is used to create a monthly report.

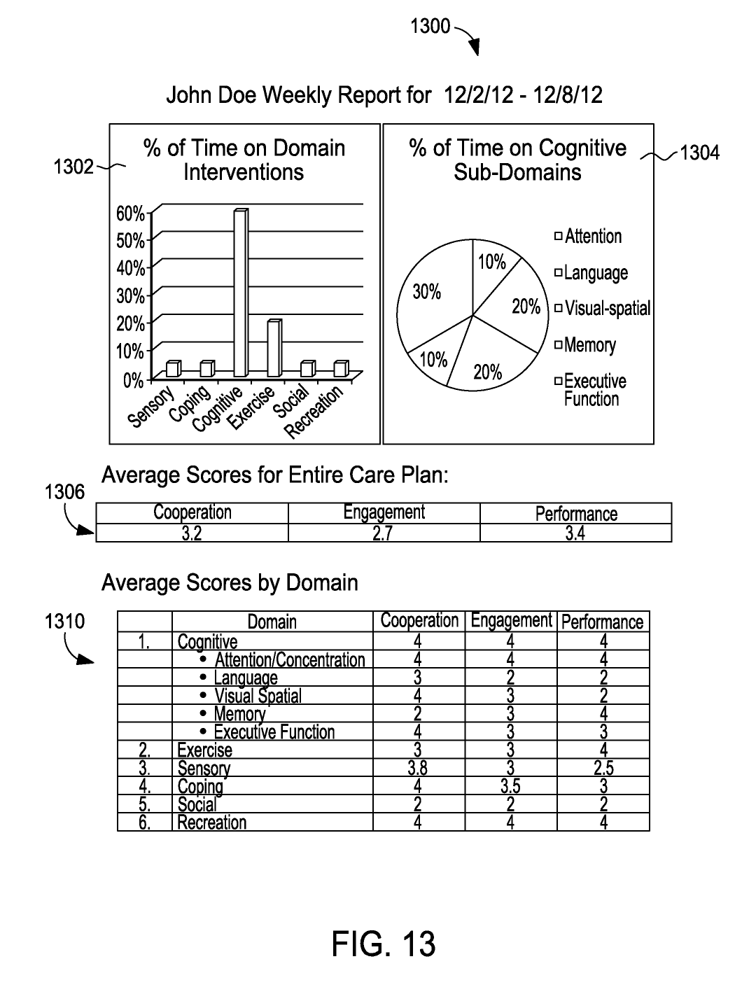

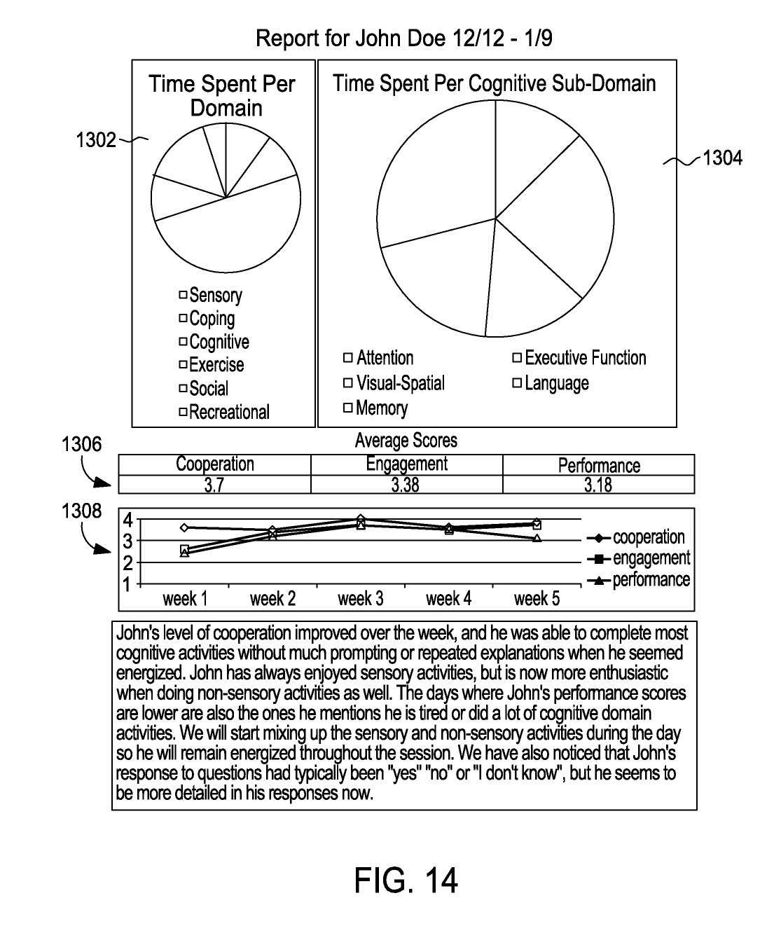

FIG. 13 is an example monthly report 1300 shared with the client. FIG. 14 is another example monthly report shared with the client. In the example embodiment, report 1300 includes a domain time spent display 1302 that indicates a breakdown of time spent on each domain and a sub-domain time spent display 1304 that indicates a breakdown of time spent on each cognitive sub-domain. Displays 1302 and 1304 may use graphs, pie charts, bar graphs, or other graphic display type to indicate the necessary information. Report 1300 also includes average scores 1306 of, for example, but, not limited to, cooperation, engagement, and performance over a selectable time range. For example, the average scores could cover the entire span of time the client has been in the program or could be a selectable time range that is less than the entire time the client has been in the program. In various embodiments, comparisons of average scores during different time ranges. The comparisons may be shown in graph form in an average score display area 1308. The scores or ratings are also provided broken down by the domain or cognitive sub-domain associated with the activities in an average scores by domain area 1310. Free hand notes are entered into a notes area 1312 of report 1300.

The cognitive therapeutic intervention program managed using IMS 106 includes a library of over 300 interventions. From this library of interventions, a custom program is selected that is adapted and revised over time to correspond with the client's needs and preferences. The interventions are targeted towards five primary cognitive domains that have been shown to be affected by dementia, as well as non-cognitive areas. The five cognitive domains include executive functioning, attention, language, visual-spatial perception and memory. An executive functioning domain includes cognitive abilities such as reasoning, problem solving, judgment, and cognitive flexibility. An attention domain refers to the ability to focus on a specific piece of information for a sustained period of time while suppressing awareness of other competing distractions. A language domain refers to the ability to execute verbal functions including spontaneous speech, speech repetition, speech comprehension, naming, reading and writing. A visual-spatial perception domain involves the ability to accurately perceive and understand the visual relationships between objects and space. A memory domain refers to the ability to retain information and utilize it later for adaptive purposes. Non-cognitive areas include coping, sensory, recreational, social, exercise and diet.

The foregoing detailed description illustrates embodiments of the disclosure by way of example and not by way of limitation. It is contemplated that the disclosure has general application to the evaluation, administration, and management of a regime of interventions to a client. It is further contemplated that the methods and systems described herein may be incorporated into existing healthcare planning systems, in addition to being maintained as a separate stand-alone application.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the disclosure or its features may have different names, formats, or protocols. Further, the system may be implemented via a combination of hardware and software, as described, or entirely in hardware elements. Also, the particular division of functionality between the various system components described herein is merely one example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any of computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

While the disclosure has been described in terms of various specific embodiments, it will be recognized that the disclosure can be practiced with modification within the spirit and scope of the claims.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by computing devices that include, without limitation, mobile devices, clusters, personal computers, workstations, clients, and servers and where the memory can include RAM memory, ROM memory, EPROM memory, EEPROM memory, and non-volatile RAM (NVRAM) memory. The above listed computing device type and memory types are examples only, and are thus not limiting as to the types of computing devices and memory usable for execution and storage of a computer program.

As will be appreciated based on the foregoing specification, the above-described embodiments of the disclosure may be implemented using computer programming or engineering techniques including computer software, firmware, hardware or any combination or subset thereof, wherein the technical effect of the methods and systems for providing interventions for chronic progressive neurodegenerative conditions using a computer device coupled to a user interface and a memory device may be achieved by performing at least one of the following steps: (a) receiving a client for evaluation, (b) determining a first level of functioning in each of a plurality of cognitive domains and non-cognitive areas, (c) comparing the determined first level of functioning to one or more threshold levels of functioning, the threshold levels determined from at least one of others than the client and previous determinations of the client, (d) determining one or more intervention activities associated with each cognitive domain and non-cognitive area where the determined functioning was less than a respective threshold level or where the determined functioning meets the threshold level but the client can still benefit from further exercise and improvement in the cognitive domain (e) administering the interventions in a usual living space of the client, (f) evaluating a second level of functioning during the administering, (g) reporting the second level of functioning, (h) evaluating each level of functioning administered over time, and (i) reporting a progress of the client over time with respect to the interventions and the evaluated levels functioning in each of the plurality of cognitive domains.

Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

Many of the functional units described in this specification have been labeled as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete components. A module may also be implemented in programmable hardware devices such as field programmable gate arrays (FPGAs), programmable array logic, programmable logic devices (PLDs) or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The above-described embodiments of a method and system for providing interventions for chronic progressive neurodegenerative conditions provides a cost-effective and reliable means for managing communications amongst providers and clients, historical recordkeeping, reporting of results and progress, documenting interventions and scores of achievement of each goal of the intervention. In addition, the above-described methods and systems facilitate periodic evaluation of progress and adjusting assigned interventions based on the progress. As a result, the methods and systems described herein facilitate managing interventions in a cost-effective and reliable manner.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for managing interventions for chronic progressive neurodegenerative conditions, the method implemented using a computer device coupled to a user interface and a memory device, the method comprising:
receiving a client for evaluation;
determining a first level of functioning in each of a plurality of cognitive domains;
comparing the determined first level of functioning to one or more threshold levels of functioning, the threshold levels determined from at least one of others than the client and previous determinations of the client;
determining one or more intervention activities associated with each cognitive domain when at least one of the determined functioning is less than a respective threshold level and the determined functioning meets the threshold level and a determination is made that the client will benefit from further exercise in the cognitive domain;
administering the interventions in a usual living space of the client;
evaluating a second level of functioning during the administering;
reporting the second level of functioning;
evaluating each level of functioning administered over time; and
reporting a progress of the client over time with respect to the interventions and the evaluated levels functioning in each of the plurality of cognitive domains.

2. The method of claim 1, further comprising modifying the administered interventions based on the evaluation of each level of functioning.

3. The method of claim 1, further comprising periodically evaluating a current level of functioning by a research and operations team.

4. The method of claim 1, wherein determining a first level of functioning in each of a plurality of cognitive domains comprises determining a first level of functioning in each of a memory area, an executive function area, an attention area, a visual-spatial area, and a language area, and non-cognitive areas including at least one of a coping area, a sensory area, a recreational area, a social area, an exercise area, and a diet area.

5. The method of claim 1, wherein determining a first level of functioning in each of a plurality of cognitive domains comprises determining a first level of functioning by direct observation of the client by at least one of the research and operations team, family members, and advocates of the client.

6. The method of claim 5, wherein determining a first level of functioning by direct observation of the client by at least one of the research and operations team, family members, and advocates of the client comprises subjectively scoring the first level of functioning on a predetermined scale.

7. The method of claim 1, wherein determining a first level of functioning in each of a plurality of cognitive domains comprises receiving information relating to a life history of the client, interests of the client, and family information of the client.

8. The method of claim 1, wherein determining one or more intervention activities associated with each cognitive domain comprises manually selecting one or more intervention activities from a plurality of available intervention activities.

9. The method of claim 1, wherein determining one or more intervention activities associated with each cognitive domain comprises limiting the plurality of available intervention activities based on the life history of the client, abilities and limitations of the client, interests of the client, and family information of the client.

10. A network-based intervention management system (IMS) for managing interventions for chronic progressive neurodegenerative conditions, the IMS comprising:
a network comprising a memory device and a computing device coupled to the memory device, the computing device programmed to:
receive client evaluation information;
receive a first level of functioning information in each of a plurality of cognitive domains and non-cognitive areas based at least in part on the received information;
compare the determined first level of functioning to one or more threshold levels of functioning, the threshold levels determined from at least one of others than the client and previous determinations of the client;
receive a selection of one or more intervention activities associated with each cognitive domain where the determined functioning was less than a respective threshold level;
receive a score of an administration of the interventions in a usual living space of the client;
receive a second level of functioning information based on the administering; and
generate a report of progress of the client over time with respect to the interventions and the evaluated levels functioning in each of the plurality of cognitive domains.

11. The system of claim 10, wherein the computing device is further programmed to receive a modification of the administered interventions based on the evaluation of at least one level of functioning.

12. The system of claim 10, wherein the computing device is further programmed to receive a periodic evaluation of a current level of client functioning by a research and operations team.

13. The system of claim 10, wherein the computing device is further programmed to receive a determination of a first level of client functioning in each cognitive domain including a memory domain, an executive function domain, an attention domain, a visual-spatial domain, and a language domain, and non-cognitive areas including at least one of a coping area, a sensory area, a recreational area, a social area, an exercise area, and a diet area.

14. The system of claim 10, wherein the computing device is further programmed to receive a determination of a first level of client functioning by direct observation of the client by at least one of the research and operations team, the interventionist and a family member.

15. The system of claim 14, wherein the computing device is further programmed to a subjective scoring of the first level of client functioning on a predetermined scale.

16. The system of claim 10, wherein the computing device is further programmed to receive information relating to a life history of the client, interests of the client, and family information of the client.

17. The system of claim 10, wherein the computing device is further programmed to receive one or more manually selected intervention activities from a plurality of available intervention activities.

18. The system of claim 10, wherein the computing device is further programmed to generate a block on at least one of the plurality of available intervention activities based on the life history of the client, interests of the client, and family information of the client, the block indicating that the at least one of the plurality of available intervention activities is not to be assigned or administered to the client.

19. One or more non-transitory computer-readable storage media having computer-executable instructions embodied thereon, wherein when executed by at least one processor, the computer-executable instructions cause the processor to:
receive client evaluation information;
receive a first level of functioning information in each of a plurality of cognitive domains and non-cognitive areas based at least in part on the received information;
compare the determined first level of functioning to one or more threshold levels of functioning, the threshold levels determined from at least one of others than the client and previous determinations of the client;
receive a selection of one or more intervention activities associated with each cognitive domain where the determined functioning was less than a respective threshold level;
receive a score of an administration of the interventions in a usual living space of the client;
receive a second level of functioning information based on the administering; and
generate a report of progress of the client over time with respect to the interventions and the evaluated levels functioning in each of the plurality of cognitive domains.

20. The computer-readable storage media of claim 19, wherein the computer-executable instructions further cause the processor to receive a determination of a first level of client functioning in each of a memory domain, an executive function domain, an attention domain, a visual-spatial domain, a language domain, and at least one non-cognitive area including a coping area, a sensory area, a recreational area, a social area, an exercise area, and a diet area.
